(19) United States
(12) Patent Application Publication
(10) Pub. No.: US 2011/0267272 A1
(43) Pub. Date: Nov. 3, 2011

(54) Panel Mount Keyboard System

(75) Inventors: Steven H. Meyer, Austin, TX (US); Kenneth A. Fuselier, Austin, TX (US)

(73) Assignee: iKey, Ltd., Austin, TX (US)

(21) Appl. No.: 13/097,742

(22) Filed: Apr. 29, 2011

Related U.S. Application Data
(60) Provisional application No. 61/330,110, filed on Apr. 30, 2010.

(51) Int. Cl. G06F 3/02; H01H 13/76

(52) U.S. Cl. 345/168; 200/5 A

(57) ABSTRACT

A keyboard system having improved protection from electromagnetic interference includes a keypad and a printed circuit board assembly. The keypad includes one or more keys and one or more keypad conductive elements for at least one of the keys. The printed circuit board assembly is coupled to the keypad. The printed circuit board assembly includes a printed circuit board having at least one switch contact area for each of one or more keys on the keypad. The printed circuit board also includes, for at least one of the keys of the keypad, one or more first side vias in a switch contact area and one or more second side vias in the switch contact area. The first side vias are electrically coupled on a first side of a switch for the key. The second side vias are electrically coupled on a second side of the switch for the key.

This application claims benefit of U.S. Provisional Application No. 61/330,110 filed on Apr. 30, 2010.

### FIELD OF THE INVENTION

The present invention relates generally to input devices and, more specifically, to keyboards. More particularly, the present disclosure relates to panel-mounted keyboards that may be suitable for use in industrial environments.

### BACKGROUND

Computer systems often receive user input through keyboard devices. In some systems, such as notebook computer systems, a keyboard is integrated into a chassis that includes some or all of the other components of the system, such as a central processing unit, memory, display, and/or peripheral control devices.

Computer keyboards can be susceptible to wear, damage, and deterioration, especially when used in industrial environments. For example, some keyboards are exposed to water, oils, or other liquids, dust, chemicals, and other contaminants that can damage the keyboard. In addition, keyboards often include mechanical components that may fail due to excessive wear, deterioration, or damage from external loads such as shock or vibration.

For all of the reasons described above, keyboards sometimes need to be removed from a computer system and replaced or repaired. Some computer systems include a removable panel mount keyboard that is attached to a chassis of the computer systems with conventional fasteners, such as screws. Replacing a panel-mounted keyboard in many existing systems can be time consuming For example, in some panel-mount keyboard systems, the keyboard is attached by fasteners that are driven from behind the face of keyboard. To gain access to the keyboard fasteners, several system components (such as hard drives, batteries, or circuit boards) and/or chassis elements (such as back or bottom covers on a chassis or case) may need to be removed and then later replaced.

Computer systems may be susceptible to electromagnetic interference. Electromagnetic interference may be generated by many sources inside or outside of a computer system, through mechanisms such as radiation, induction, and conduction. In some cases, electromagnetic interference is introduced into a computer system at or through a keyboard. For example, in some keyboards, a circuit board carrying key switches for the keyboard has numerous long traces and fingers on the surface of the circuit board. These traces and fingers provide conductive paths to the various keys. Long traces and fingers may, however, provide a coupling path for electromagnetic radiation from components such as semiconductor devices, electric motors, and power supply components. Electromagnetic interference resulting from such coupling may cause the keyboard or other components of a computer system to malfunction.

### SUMMARY OF INVENTION

Keyboard systems and methods of making and using keyboard systems are described herein. In one embodiment, a keyboard system, and associated methods of making and using, includes a keypad and a printed circuit board assembly. The keypad includes one or more keys and one or more keypad conductive elements for at least one of the keys. The printed circuit board assembly is coupled to the keypad. The printed circuit board assembly includes a printed circuit board having at least one switch contact area for each of one or more keys on the keypad. The printed circuit board also includes, for at least one of the keys of the keypad, one or more first side vias in a switch contact area and one or more second side vias in the switch contact area. The first side vias are electrically coupled on a first side of a switch for the key. The second side vias are electrically coupled on a second side of the switch for the key. In some embodiments, as switch included one or more vias for each side of the switch. In some embodiments, a switch includes two or more vias for each side of the switch. The switch for the key closes when at least one of the keypad conductive elements bridges at least one first side via in the switch contact area and at least one second side via in the contact area. The printed circuit board for the keyboard comprises for at least one key, one or more first side vias in a switch contact area and for the at least one key, one or more second vias in the switch contact area. In some embodiments, at least one of the first side vias is configurable to couple with a first side of a switch circuit for the key, wherein at least one of the second side vias is configurable to couple with a second side of a switch circuit for the key, wherein a switch in the switch circuit is configurable to close when at least one of the first side vias in the contact area is bridged with at least one of the second side vias in the contact area.

In an embodiment, a keyboard system for panel-mounting in a chassis of a computer system includes a keyboard assembly and a bezel. The keyboard assembly includes a keypad and a printed circuit board coupled to the keypad. The bezel is used to mount the keyboard assembly in the chassis. The bezel holds the fasteners such that the fasteners can be coupled with the chassis. The fasteners for the keyboard assembly may be driven from the front of the keyboard assembly into the chassis. In some embodiments, a keyboard assembly is electrically coupled to a chassis ground through a bezel and an electrically conductive gasket between the bezel and the chassis. In some embodiments, the keyboard system, and/or the computer system in which the keyboard system is installed, is configured to meet a radiated susceptibility test standard under MIL-STD-461E, RS103, at a field strength level of 200 volts/meter. In some embodiments, the keyboard system has a low profile.

In an embodiment, an improved method of protecting from electromagnetic interference in a keyboard system comprises providing a keypad comprising two one or more keys and one or more keypad conductive elements for at least one of the keys; providing a printed circuit board assembly coupled to the keypad. The printed circuit board assembly comprises a printed circuit board comprising at least one switch contact areas for each of two one or more keys on the keypad. For at least one of the keys of the keypad, one or more first side vias in a switch contact area are electrically coupled on a first side of a switch for the key, and one or more second side vias in the switch contact area are electrically coupled on a second side of the switch for the key. The switch for the key is configurable to close when at least one of the keypad conductive elements bridges at least one first side via in the switch contact area and at least one second side via in the switch contact area.

### BRIEF DESCRIPTION OF THE DRAWINGS

FIG. 1 illustrates an embodiment of a computer system including a keyboard that is removable from a chassis of the computer system.

FIG. 2 is a partially exploded view of the computer system shown in FIG. 1.

FIG. 3 illustrates a cross section of a keyboard assembly installed in a chassis according to one embodiment.

FIG. 4 illustrates a bottom view of a keyboard assembly according to one embodiment.

FIG. 5 illustrates a key including keypad conductive elements and corresponding contact areas on a keyboard PCB, according to one embodiment.

FIGS. 6A-6D are schematic diagrams illustrating conductive keypad elements for a key that can bridge different combinations of vias on a keyboard PCB.

FIG. 7 illustrates a cross sectional view of a keyboard PCB according to one embodiment.

FIG. 8 illustrates a layout of a circuit board for a keyboard according to one embodiment according to one embodiment.

FIGS. 9A-9G illustrates a detail view of a keyboard PCB for several types of keys according to one embodiment.

FIG. 10 illustrates a layout diagram of one embodiment of a pattern of vias for a contact area.

FIG. 11 illustrates a layout diagram of a portion of a printed circuit board for a key that includes multiple contact areas according to one embodiment.

FIG. 12 is a schematic diagram illustrating a switch for a key including multiple vias according to one embodiment.

FIG. 13 is an exploded view of a keyboard assembly including a keyboard PCB and keypad stacked on a bezel according to one embodiment.

FIG. 14 illustrates a layout of a circuit board for a keyboard according to one embodiment.

FIGS. 15A-15C illustrates a detail view of a keyboard PCB for several types of keys according to one embodiment.

FIG. 16 illustrates a layout diagram of one embodiment of a pattern of vias for a contact area according to one embodiment.

FIG. 17 illustrates a layout diagram of a portion of a printed circuit board for a key that includes multiple contact areas according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

As used herein, “bridge” includes electrically connecting one element with another. For example, electrical contacts on either of two sides of a switch may be bridged to one another.

As used herein, “chassis” refers to a structure or element that supports another element, or to which other elements can be mounted. For example, a chassis may support circuit boards, a keyboard assembly, disk drives, and other components in a laptop computer system. A chassis may have any shape or construction, including a frame, a plate, a box, or a combination thereof.

As used herein, “circuit board” refers to any circuit module that carries one or more other circuit modules or components. “Circuit board” includes, but is not limited to, a printed circuit board made of epoxy-glass and metal layers.

As used herein, “circuit module” refers to any module that includes or carries elements of an electrical circuit, electrical components (including, but not limited to, semiconductor devices or resistors), or conductors (e.g., wires, traces).

As used herein, “conductive keypad element” includes any conductive element in or on a keypad. In one embodiment, a conductive keypad element is a carbon pill.

As used herein, a “switch contact area” means an area of a circuit board in which contact can be made between two or more elements to close a switch.

As used herein, “panel-mounted” or “panel-mounting” refers to a mounting of a keyboard or other device in an opening, socket, recess, or cavity in a panel or chassis. For example, a chassis or case of a notebook computer system may include a top panel having an opening for mounting a keyboard. As another example, a cabinet for an industrial control system may include a control panel having an opening for mounting a keyboard.

As used herein, “via” refers to a conductive element, such as a metalized or plated hole, that can be used to interconnect two or more layers or sides of a circuit board. As used herein, a “blind via” means a via that is exposed on only one side of a circuit board. In some cases, a via includes plating at the surface of a circuit board. In some embodiments, a via includes a surface pad or surface ring. The surface pad or ring may have a larger diameter than the hole for the via. For example, a via in a hole of diameter 0.010 inches may include an annular ring at the surface of the circuit board having an outer diameter of 0.038 inches.

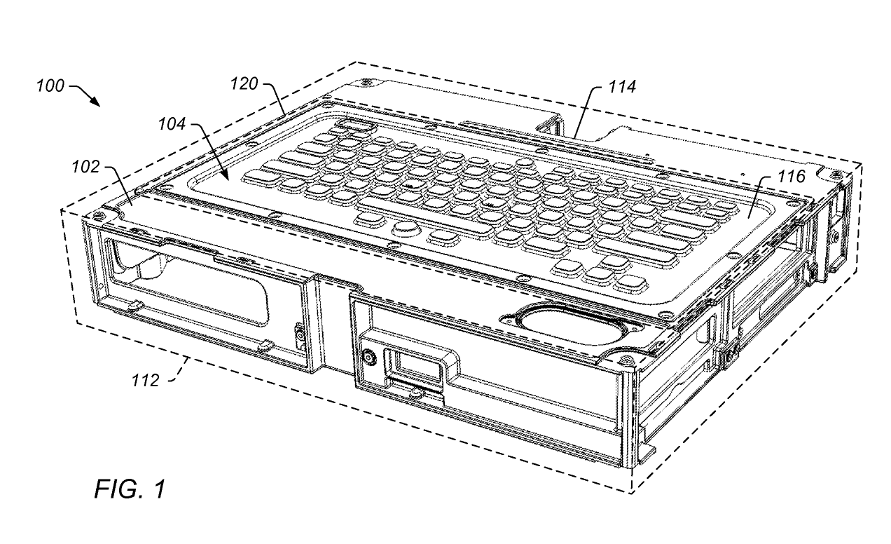

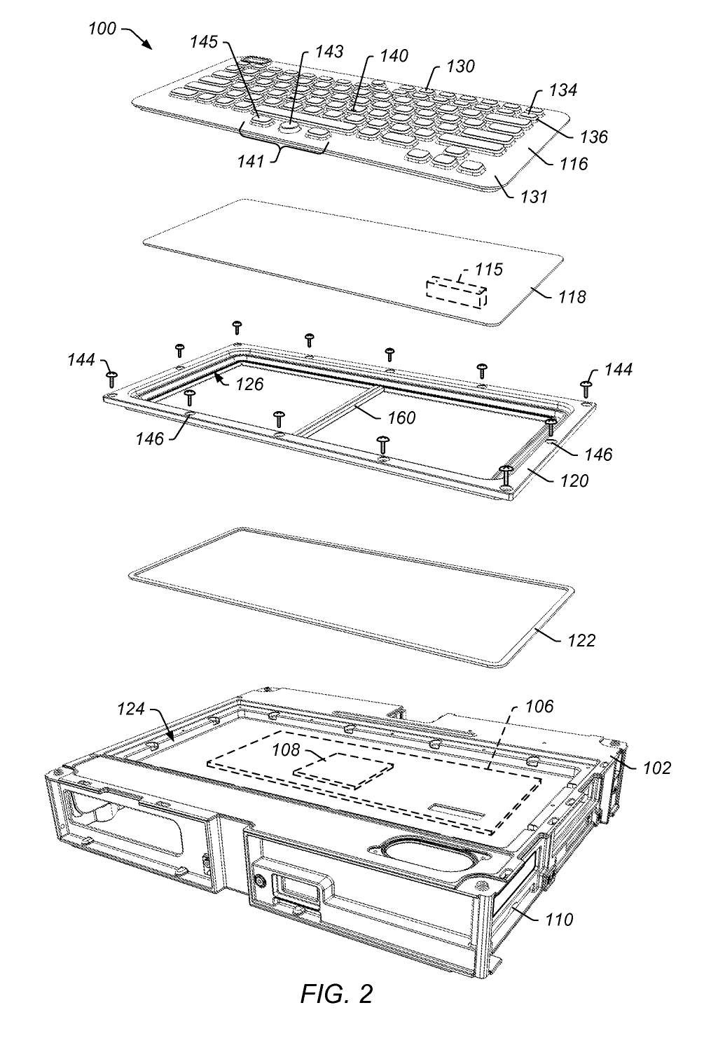

In some embodiments, a computer system includes a panel-mounted keyboard. FIG. 1 illustrates an embodiment of a computer system including a keyboard that is removable from a chassis of the computer system. FIG. 2 is a partially exploded view of the computer system shown in FIG. 1. Computer system 100 includes chassis 102, keyboard assembly 104, and motherboard assembly 106. Motherboard assembly 106 includes central processing unit 108. Central processing unit 108 may perform and control various computing operations in computer system 100. Motherboard assembly 106 may be coupled to memory devices 110. Lower case 112 and upper case 114 (which, in FIG. 1, are depicted schematically as dashed lines for clarity) may combine to house chassis 102.

Keyboard assembly 104 may be electrically coupled to motherboard assembly 106 by way of connector 115. In some embodiments, mating halves of connector 115 automatically couple when keyboard assembly 104 is installed in chassis 102. Keyboard assembly 104 may serve as a user input device for computer system 100.

Keyboard assembly 104 is mountable to chassis 102. Keyboard assembly 104 includes keypad 116, keyboard PCB 118, and bezel 120. Bezel 120 may couple to chassis 102 in bezel seat 124 of chassis 102. Gasket 122 is provided between bezel 120 and chassis 102. In some embodiments, gasket 122 is compressed between bezel 120 and chassis 102. Gasket 122 may provide a seal between bezel 120 and chassis 102. In certain embodiments, gasket 122 is made of an electrically conductive material. In some embodiments, keyboard assembly 104 is electrically coupled to a chassis ground of chassis 102 through bezel 120 and gasket 122. In certain embodiments, a chassis ground may be established with electrically conductive adhesives between elements of a system.

Keypad 116 couples with keyboard PCB 118. Keypad 116 and keyboard PCB 118 are mounted in bezel 120 in keyboard seat 126.

Keypad 116 includes keys 130 and keypad base 131. In some embodiments, keypad 116 is made of a sheet of elastomeric material, such as rubber. In certain embodiments, the sheet is continuous over the entire keyboard. A keypad including a continuous sheet of material may seal fluids, dust, contaminants, and other elements in the environment out of the computer system. In the embodiment shown in FIG. 1, keys 130 include raised pads 134. Raised pads 134 are connected to base (keyboard conductive elements) 132 by way of webs 136. Webs 136 may be flexible to allow raised pads 134 to deflect downwardly when pressed by a user. Keys 130 include markings 140. Markings 140 may indicate a function of the key (such as a letter, number, symbol, or function). Markings 140 may be stamped on raised pads 134.

Keyboard PCB 118 may include switches and conductors for receiving input when the various keys 130 of keypad 116 are pressed by a user. In some embodiments, keyboard PCB 118 may include light emitting diodes (“LEDs”). The LEDs may backlight keys 130 when the keys are pressed.

Keyboard assembly 104 includes pointer device 141. Pointer device 141 includes sensor 143 and arrow keys 145. Sensor 143 may sense user input. In one embodiment, sensor 143 has an “eraser head” type input. In certain embodiments, the keypad portions of pointer device 141 are similar in structure and arrangement similar to that described above with respect to keys 130.

In some embodiments, a keyboard is installed on a computer system from the front of the keyboard. In one embodiment, a keyboard is installed with fasteners driven from the front of the keyboard. As used herein, “front” means the face of a keyboard on which the keys are exposed and/or operated. For example, in the embodiment shown in FIG. 1, fasteners 144 are driven from the top of computer system 100. Fasteners 144 may secure keyboard assembly 104 to chassis 102. Securing fasteners from the front of a keyboard (rather than, for example, from behind the keyboard) may eliminate the need to remove other components in a computer system to remove or install a keyboard.

Bezel 120 includes holes 146. Each of holes 146 may be a through-hole that receives one of fasteners 144. Fasteners 144 may couple keyboard assembly 104 to chassis 102. In one embodiment, fasteners 144 are screws. In other embodiments, various other suitable fasteners may be used to secure a keyboard assembly to a computer system, such as cam-lock fasteners, pins, or clips. In certain embodiments, fasteners 144 are captive fasteners. Chassis 102 may include tapped holes for receiving fasteners.

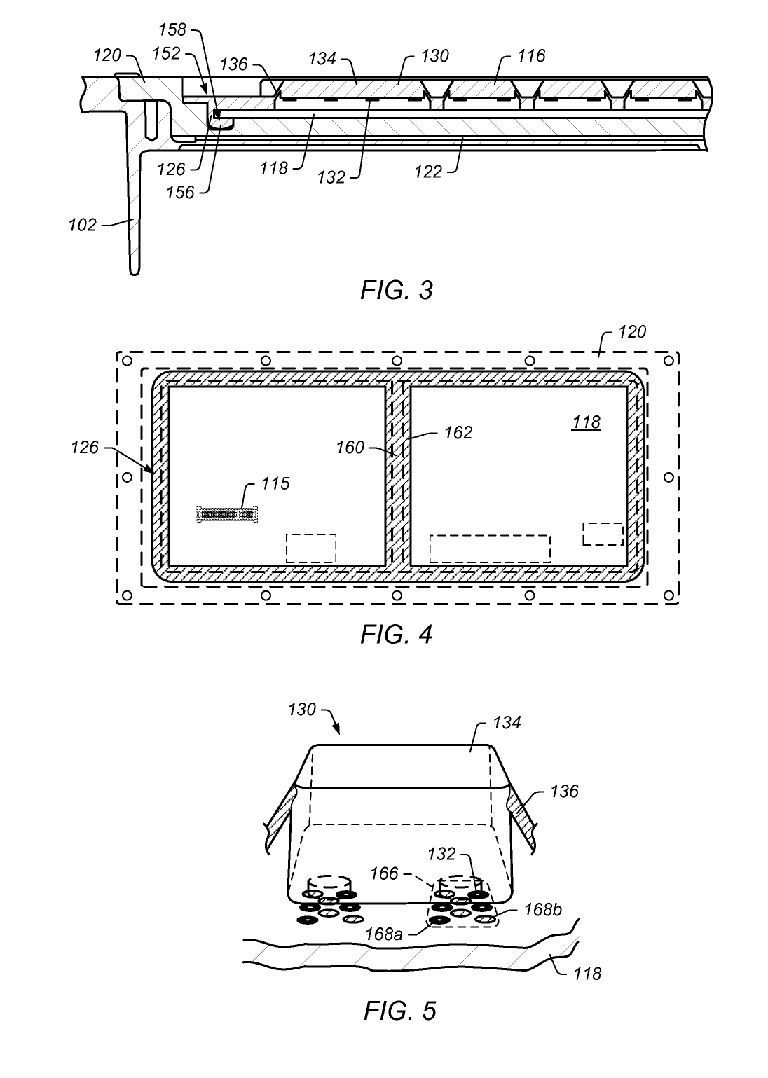

FIG. 3 illustrates a cross section of a keyboard assembly installed in a chassis according to one embodiment. Keypad 116 is coupled to keyboard PCB 118. As discussed above with respect to FIG. 1, keypad 116 may be made of an elastomeric material. As shown in FIG. 3, keypad 116 may wrap around the edge of keyboard PCB 118. In some embodiments, a keypad wraps around the edge of a keyboard PCB over the entire perimeter of the keyboard. A wraparound keypad may establish a proper alignment of a keypad with a keyboard PCB. A wraparound keypad may seal contaminants and fluids out of a chassis. In certain embodiments, an adhesive, such as an electrically conductive RTV adhesive made by Dow Corning, is provided at the edge of keyboard and a wraparound keypad.

In some embodiments, a keyboard system including a bezel-mounted keypad/keyboard PCB assembly, such as described above relative to FIG. 3, is provided in a keyboard system with a low mounting profile and/or thin height. In some embodiments, key travel and pointer performance may be improved.

Keypad 116 is supported on keyboard PCB 118. Keypad base 131 may be directly above keyboard PCB 118. Raised pads 134 may be suspended on webs 136 above keyboard PCB 118. Keypad 116 includes keypad conductive elements 132. Keypad conductive elements 132 may be, for example, carbon “pills” or discs on the bottom of raised pads 134. Keypad conductive elements 132 may be electrically conductive. When one of keys 130 is pressed by a user, one or more of keypad conductive elements 132 on the key may contact switch elements on the surface of keyboard PCB 118 to close a switch for that key. The closing of the switch for the key may be used as a signal that the key has been pressed.

Keypad 116 and keyboard PCB 118 may mount in pocket 152 in bezel 120. Pocket 152 of bezel 120 includes seat 126. Keypad 116 includes ridge 156. Ridge 156 of keypad 116 may extend into groove 158 in seat 126 of bezel 120. As illustrated in FIG. 2, in some embodiments, a ridge and corresponding groove in a bezel extend around the edge of a keypad over the entire perimeter of the keypad. Ridge 156 may compress in groove 158. Compression of ridge 156 of keypad 116 may enhance a seal between bezel 120 and keypad 116. In certain embodiments, sealing portions of keypad 116 may be electrically conductive.

In some embodiments, a bezel includes one or more cross members. The cross members may provide support and/or structural reinforcement for a keyboard PCB. Referring again to FIG. 2, bezel 120 includes cross member 160. Cross member 160 may support and/or limit deflection of keyboard PCB 118.

In some embodiments, a bezel may couple with conductive elements on a keyboard PCB, such as a ground plane. FIG. 4 illustrates a bottom view of keyboard assembly 104. Keyboard PCB 118 includes ground plane 162. Ground plane 162 may extend around a perimeter of a bottom surface of keyboard PCB 118 in the area of seat 126 and in the area of cross member 160. Ground plane 162 of keyboard PCB 118 may contact and/or electrically couple with seat 154 and cross member 160 of bezel 120. In some embodiments, a material to provide an EMI and/or liquid seal between ground plane 162 and seat 126 and cross member 160 of bezel 120. In certain embodiments, an electrically conductive silicone adhesive, such as an RTV adhesive made by Dow Corning, is provided between ground plane 162 and seat 126 and cross member 160 of bezel 120.

As discussed above, keypad conductive elements on a key may contact switch elements on the surface of keyboard PCB to close a switch associated with a key. In some embodiments, each keypad conductive element on a keypad may correspond to a contact area on a PCB. The contact area corresponding to a keypad may have multiple PCB conductive elements. In embodiments, the PCB conductive elements are vias in the printed circuit board. FIG. 5 illustrates a key including keypad conductive elements and corresponding contact areas on a keyboard PCB, according to one embodiment.

Key 130 is provided on keypad 116. Key 130 includes raised pad 134. Conductive keypad elements 132 are provided on bottom of raised pad 134. Under each of conductive keypad elements 132, a contact area 166 is provided on keyboard PCB 118.

In the embodiment illustrated in FIG. 5, each conductive keypad element corresponds to multiple vias. The multiple vias may be within a contact area 166 for corresponding to the conductive keypad element. Contact area 166 includes vias 168a and 168b. Vias 168a and 168b may extend through all or a portion of keyboard PCB 118.

Vias 168a may be electrically coupled on one another. Vias 168a may form one side of a switch for key 164. Vias 168b may be electrically coupled on one another. Vias 168b may form a second side of a switch for key 164. When key 164 is pressed by a user, one or more of conductive keypad elements may bridge at least one of vias 168a on the first side of the switch for the key to at least one of vias 168b on the second side of the switch.

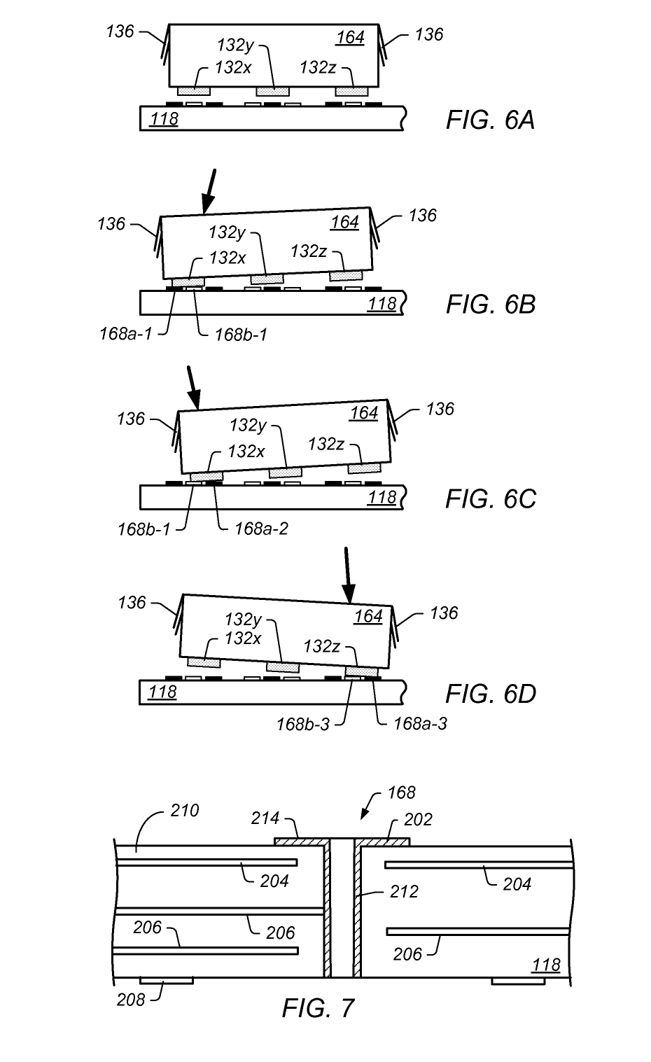

As described above with respect to FIG. 3, raised pad 134 may be suspended on web 136. Web 136 and/or raised pad 134 may elastically deform (for example, stretch, bend, or flex) such that the orientation and position at which raised pad 134 comes down on keyboard PCB 118 may vary depending on how the key is loaded when pressed by a user. As such, the particular vias 168a and 168b that are bridged in any given instance may depend on how the key is pressed. FIGS. 6A-6D are schematic diagrams illustrating conductive keypad elements for a key that can bridge different combinations of vias on a keyboard PCB, depending on the position and direction of the load applied to the key. In FIGS. 6A-6D, the height and diameter of vias 168 are exaggerated for illustrative purposes.

In FIG. 6A, no force is applied to key 164, and key 164 is suspended above keyboard PCB 118. In FIG. 6B, a user applies a load having a leftward force component to a point on the left side of the key 164. Keypad conductive element 132x bridges via 168a-1 to via 168b-1 on keyboard PCB 118. In FIG. 6C, a user applies a load having a rightward force component to a point on the left side of the key 164. Keypad conductive element 132x bridges via 168a-2 to via 168b-1. In FIG. 6D, a user applies a load having a rightward force component to a point on the right side of the key 164. Keypad conductive element 132z bridges via 168a-3 to via 168b-3. In each of the cases of contacts described above relative to FIGS. 6B-6D, a computer system may detect that the switch for key 164 has been closed and respond accordingly.

For illustrative purposes, the key loading variations, key displacements, and combinations of vias that are bridged in FIGS. 6A-6D are described in a linear context (namely, left or right on FIGS. 6A-6D). It will be understood, however, that a pattern of vias in a contact area may accommodate load variations and key displacements in any direction relative to a printed circuit board (left to right, front to back, or any combination thereof).

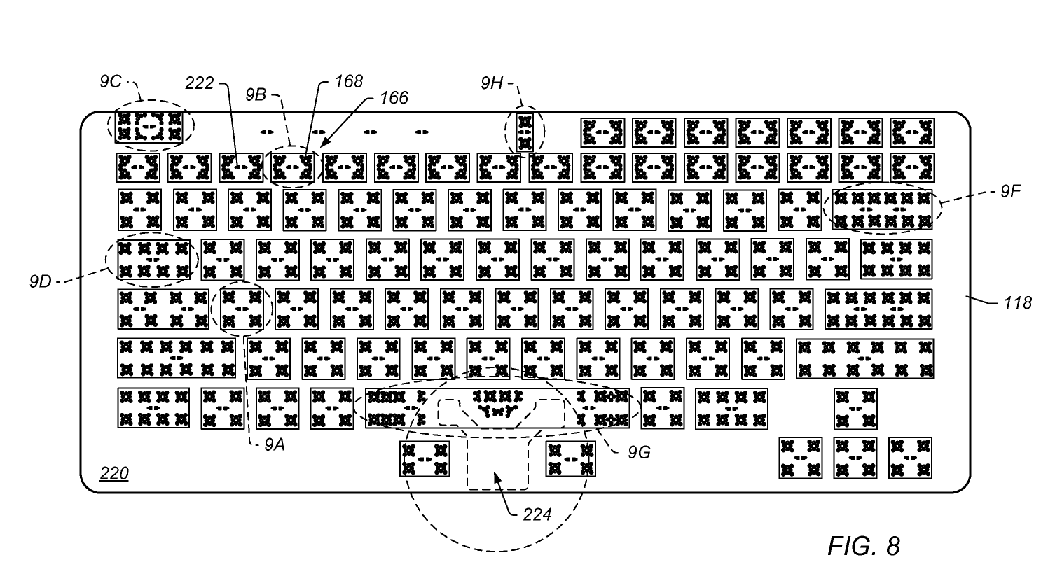

FIG. 7 illustrates a cross sectional view of a keyboard PCB according to one embodiment. Keyboard PCB 118 includes top layer 202, ground plane 204, key switch signal layers 206, and component layer 208. Non-conductive material 210 separates top layer 202, ground plane 204, key switch signal layers 206, and component layer 208. Key switch signal layers 206 may include, for example, traces that electrically connect vias in keyboard PCB 118 to switch circuits in keyboard PCB 118. Component layers 208 may include pads for components (such as semiconductor devices, resistors, and capacitors) mounted to keyboard PCB 118. In one embodiment, a keyboard PCB is a six-layer printed circuit board. In one embodiment, keyboard PCB 118 is about 9¼ inches by about 4 inches by about 0.042 inches thick.

Via 168 includes barrel 212 and surface ring 214. In some embodiments, barrel 212 is a plated through hole. As illustrated in FIG. 7, barrel 212 may extend from the top surface of keyboard PCB 118 to the bottom surface of keyboard PCB 118. In certain embodiments, some or all of the vias for key switches in a keyboard PCB may be blind vias.

In some embodiments, ground plane layer 204 is a dedicated chassis ground plane. In certain embodiments, a ground plane layer may partially extend under a portion of a conductive surface of one or more vias. For example, as illustrated in FIG. 7, ground plane 204 may undercut the outside radius of surface ring 214 such that the footprint of surface ring 214 overlaps the foot print of the ground plane of ground plane layer 202.

The number of keypad conductive elements for each key may vary from embodiment to embodiment and, within any embodiment, from key to key. The number of contact areas on a circuit board for a particular key may also vary. In some embodiments, the number of conductive elements and contact areas for a key varies depending on the size of a key. Larger keys may have more keypad conductive elements, PCB contact areas, and vias, for example, than smaller keys. Keypad conductive elements may be distributed over the area of a raised pad for a key. In some embodiments, keypad conductive elements for a key are placed near the outside edges of a raised pad for the key. In some embodiments, keypad conductive elements for a key are placed near the corners of the raised pad for the key. Keypad conductive elements may be any shape, including round, ovate, square, rectangular, or irregular.

In some embodiments, each keypad conductive element for a key has a corresponding contact area on a keyboard. In certain embodiments, however, there need not be a one-to-one correspondence between keypad conductive elements and contact areas. For example, one keypad conductive element may cover one or more contact areas. Conversely, one or more keypad conductive elements may be provided over a single contact area. A keypad conductive element may be larger or smaller than a corresponding contact area. In certain embodiments, a key has only one keypad conductive element. In one embodiment, an entire raised pad of a key is electrically conductive. In one embodiment, an entire keypad is electrically conductive.

FIG. 8 illustrates a layout of a circuit board for a keyboard according to one embodiment. Keyboard PCB 118 includes board 220 and contact areas 166. Contact areas include vias 168 and light emitting diode pads 222. Light emitting diodes may be mounted at light emitting diode pads 222 to backlight individual keys on the keyboard assembly. Keyboard PCB 118 includes pointer sensor 224. In some embodiments, pointer sensor 224 is shielded, for example, to reduce electromagnetic interference in the signals from pointer sensor 224.

Vias 168 may be through vias, blind vias, or a combination thereof. In some embodiments, a keyboard PCB includes blind vias in portion of the PCB where the bottom layer of the board includes a ground plane (such as the ground plane around the bottom edge of keyboard PCB 118 shown in FIG. 4).

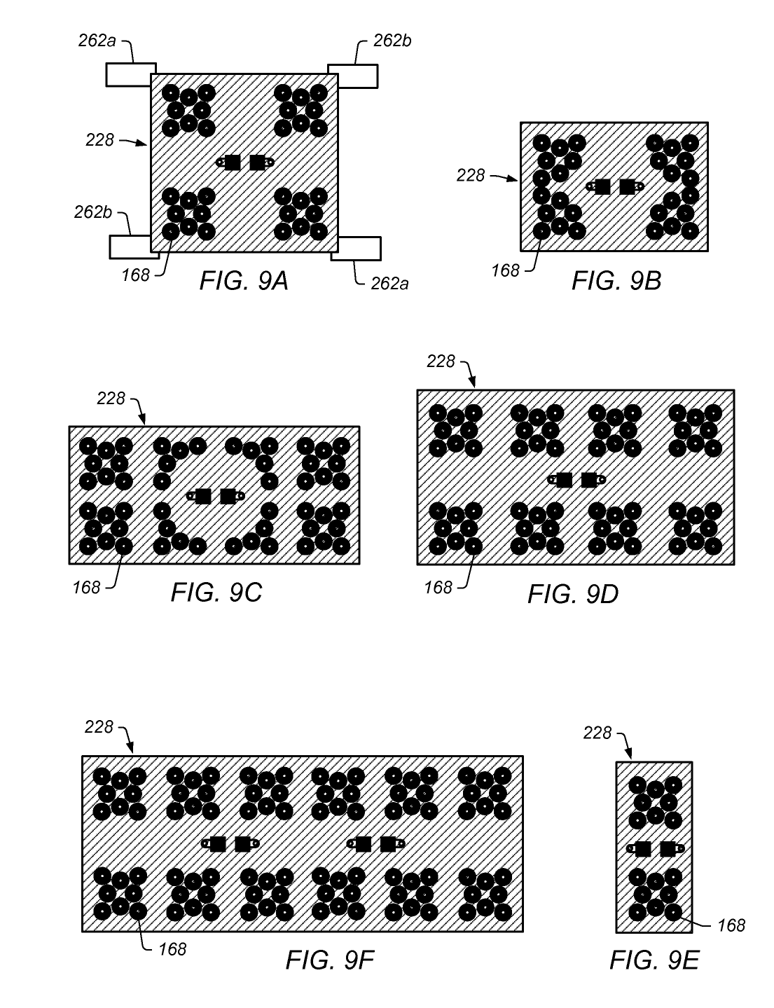

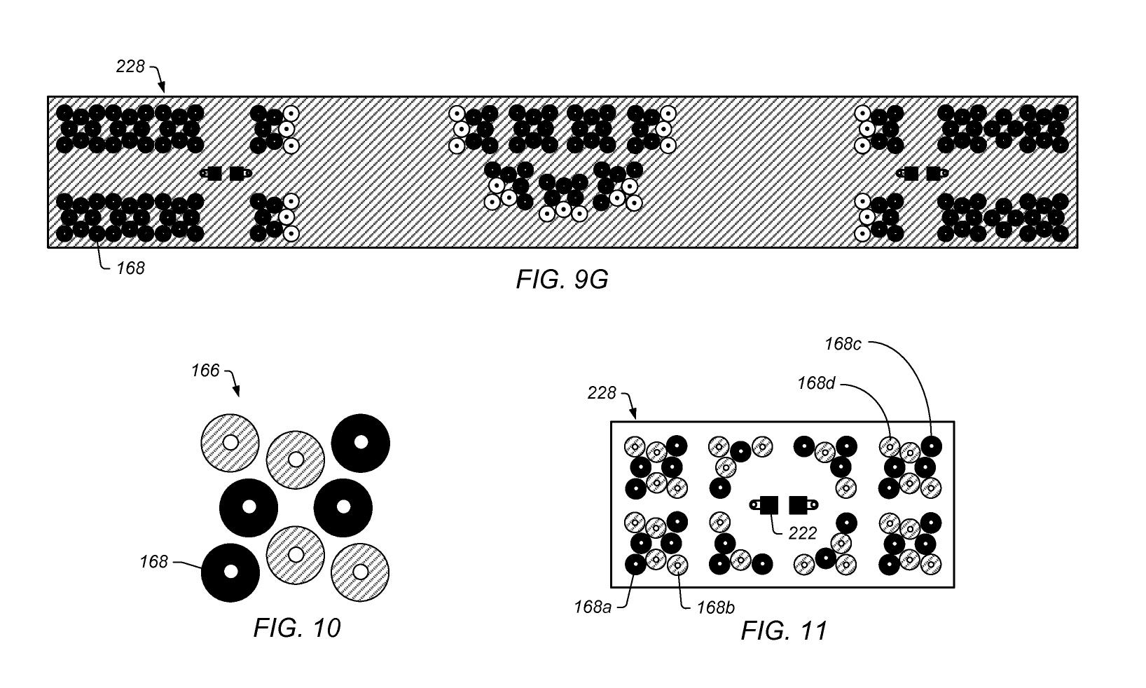

As discussed above, the number of contact areas and vias associated with a particular key may vary depending on the size and function of the key. For some keys, the pattern of vias may be the same in all of the contact areas for the key. For other keys, different contact areas for the key may have a different pattern of vias than other contact areas. FIGS. 9A-9G illustrates a detail view of a keyboard PCB for several types of keys. In each of the embodiments shown in FIGS. 9A-9G, zone 228 may be a keep-away zone around vias 168. A ground plane for the keyboard PCB, may be squared off up to zone 228. In some embodiments, only key vias and LED vias are allowed in keep away zone 228. In certain embodiments, a 0.030 inch minimum spacing is maintained between the edge of keep away zone 228 and vias/LEDs.

Although in FIGS. 9A-9G, each of the keys has two rows of associated contact areas, a keyboard printed circuit board may in other embodiments include one or any number of rows of contact areas for a key. In one embodiment, a keyboard printed circuit board includes a single row of contact elements. In another embodiment, a keyboard printed circuit board includes a single contact area for a key.

In certain embodiments, the number of vias may be selected to control a sensitivity of a key. For example, as shown in FIG. 9G, vias 168 may be spaced close to another. A larger number of vias may increase a probability of bridging vias in the contact areas associated with the key. An increased probability of the bridging vias may increase sensitivity of the key. The pattern of vias shown in FIG. 9G may be associated with a space bar for the keyboard, for example, where a relatively high sensitivity may be desired.

As discussed above, different vias within a contact area for a key may be coupled on one side or the other of a switch for the key. FIG. 10 illustrates a layout diagram of one embodiment of a pattern of vias for a contact area. Vias 168a may be coupled on one side of a switch for a key. Vias 168b may be coupled on a second side of a switch for key. A conductive element on a keypad (such as conductive keypad element 132 described above with respect to FIG. 5) may conductively bridge one or more of vias 168a with one or more of vias 168b.

The arrangement of vias 168a and vias 168b may be selected to increase the likelihood of closing a switch for a key when the key is pressed by a user. In some embodiments, a pattern of vias 168a and vias 168b is selected so that at least one of the vias is immediately adjacent to one or more vias on the other side of the switch. In some patterns, the vias on either side of the switch may be alternated over at least a portion of the pattern. In certain embodiments, a contact area for a key includes an equal number of vias on each side of the switch. In certain embodiments, a contact area for a key includes one or more vias for each side of the switch. In certain embodiments, the arrangement of vias of the two sides of a key switch within a contact area are arranged to achieve a desired sensitivity range for a key.

In one embodiment, vias 168a and 168b have a hole diameter of about 0.010 inches. Surface ring 214 may be circular and have an outer diameter of about 0.038 inches. Surface ring 214 may be an exposed ground. The spacing between horizontal and vertical centers of the vias for each row or column may be about 0.042 inches. In some embodiments, a 0.030 inch minimum spacing is maintained between vias 168a and 168b and a keep away zone, such as keep away zone 228 described above relative to FIGS. 9A-9G. In certain embodiments, a solder mask protrudes about 0.010 inches into a keep away zone.

FIG. 11 illustrates a layout diagram of a portion of a printed circuit board for a key that includes multiple contact areas 166. Each of contact areas 166 includes multiple vias 168a and multiple vias 168b. In the central most contact areas, one or more vias 168a and one or more vias 168b are arranged to provide spacing for LED pads 222.

In some embodiments, a keyboard PCB having multiple vias for key switch elements may eliminate a need for long traces on the surface of a keyboard PCB for the switch. Eliminating traces in a keyboard PCB may reduce susceptibility of the keyboard PCB and/or the computer system to electromagnetic interference. In some embodiments, a system with keyboard including key switch vias meets a radiated susceptibility test standard under MIL-STD-461E, RS103, at a field strength level of 200 volts/meter.

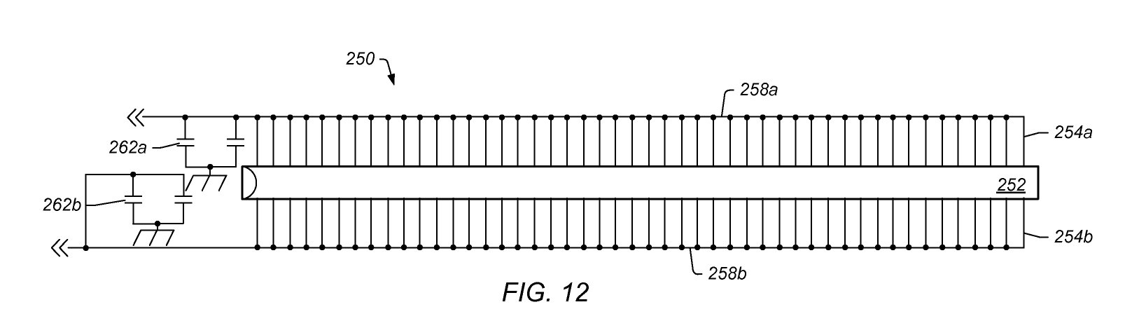

Vias for a key switch, such as vias 168a and vias 168b shown in FIGS. 10 and 11, may be included in a circuit to provide a signal that a key has been pressed. In some embodiments, all of the vias on one side of switch for a key are coupled to one another, and all of the vias on the other side of the key are coupled to one another. FIG. 12 is a schematic diagram illustrating a switch for a key including multiple vias according to one embodiment. Switch circuit 250 includes switch 252. Lines 254a may each be coupled to vias on one side of the switch, such as vias 168a. Vias 168a may correspond to a row-side of switch 252. Lines 254b may each be coupled to vias on the other side of the switch, such as vias 168b. Lines 254a may be commonly coupled, as reflected by line 258a. Lines 254b may be commonly coupled, as reflected by line 258b. Vias 168a may correspond to a column-side of switch 252.

Although in the embodiments described above, all of the vias are on one side or the other of a single switch for the key, in some embodiments, may be grouped or paired into one or more switches for a key. For example, a given key or contact area may include sets of vias 168a, vias 168b, vias 168c, and 168d. Vias 168a and vias 168b may form opposing sides of one switch, while vias 168c and 168d form opposing sides of a second switch. In certain embodiments, individual vias in a contact area may be paired to form a switch.

Switch circuit 250 includes capacitors 262a and 262b. Capacitors 262a are between line 258a (which may correspond to a row side of switch 252) and ground. In one embodiment, capacitors 262a and 262b are 0.01 microfarads. Capacitors 262b are between line 258b (which may correspond to a column side of switch 252) and ground. In some embodiments, capacitors 262a and 262b are located on the corners of a key area. For example, referring to FIG. 9A, a pair of capacitors 262a are located on two opposing corners of keep away zone 228 (northwest and southeast, for example), and capacitors 262b are located on the other two opposing corners of keep away zone 228 (northeast and southwest, for example).

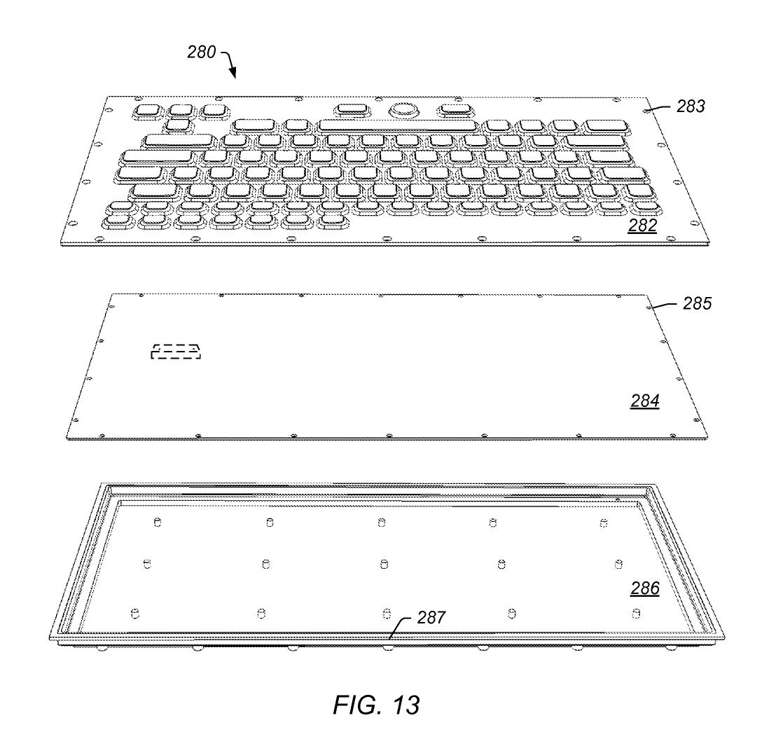

In some embodiments, a panel-mount keyboard assembly includes keyboard PCB and keypad stacked on a bezel. The bezel may couple with a panel in the chassis of a computer system. FIG. 13 is an exploded view of a keyboard assembly including a keyboard PCB and keypad stacked on a bezel. Keyboard assembly 280 includes keypad 282, keyboard PCB 284, and bezel 286. Keyboard PCB 284 is supported on bezel 286. Keypad 282 is supported on keyboard PCB 284. Fasteners (not shown for clarity) may be installed from the front of keypad 282 into a chassis through holes 283 in keypad 282, holes 285 in keyboard PCB 284, and holes 287 in bezel 286. In some embodiments, bezel 286 and/or keyboard PCB 284 may include features such as ribs or pins, to align keypad 282 relative to keyboard PCB 284 and/or bezel 286.

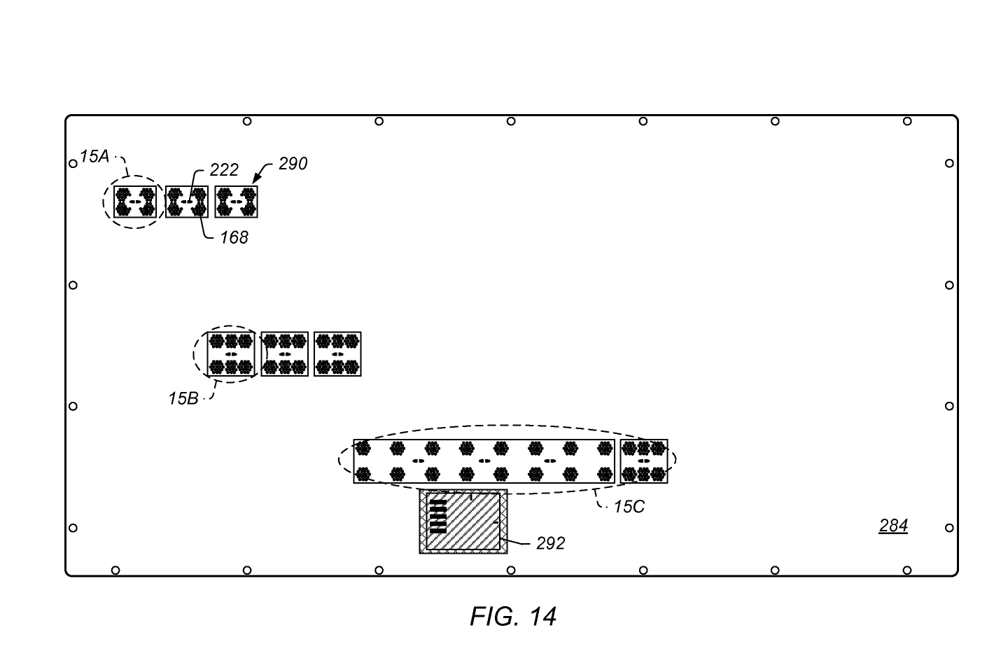

FIG. 14 illustrates a layout of a circuit board for a keyboard according to one embodiment. Keyboard PCB 284 includes contact areas 290. Contact areas 290 include vias 168 and light emitting diode pads 222. Keyboard PCB 284 includes pointer sensor 292. In some embodiments, pointer sensor 292 is shielded, for example, to reduce electromagnetic interference in the signals from pointer sensor 292. Vias 168 may be through vias, blind vias, or a combination thereof

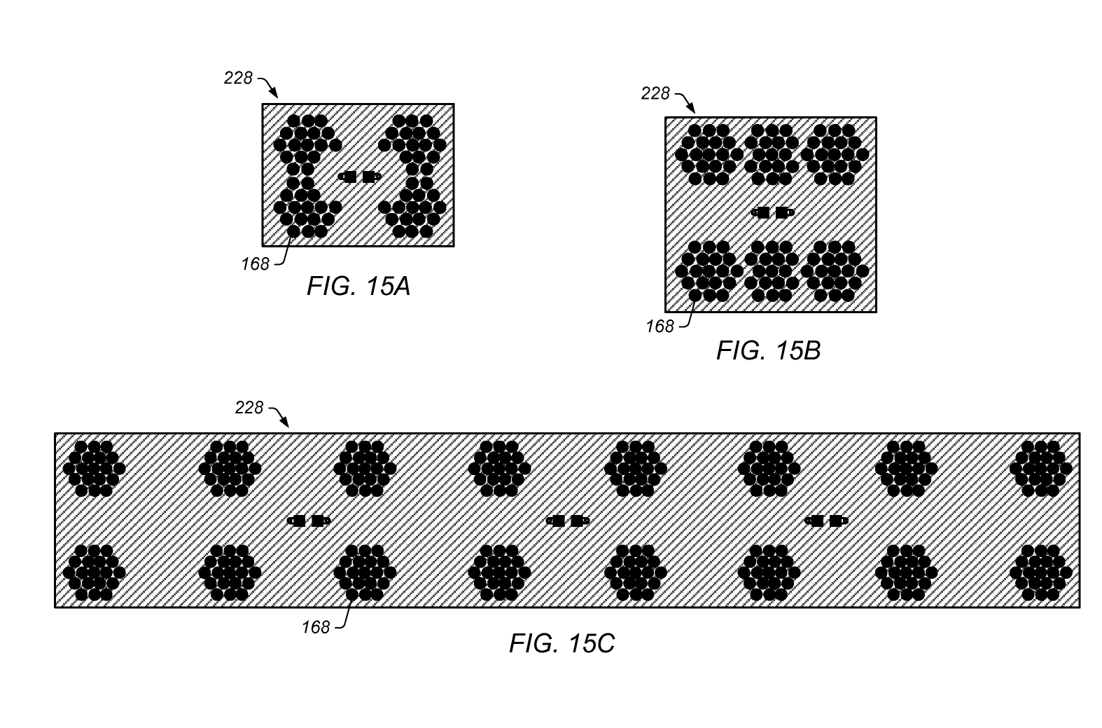

FIGS. 15A-15C illustrates a detail view of a keyboard PCB for several types of keys. In each of the embodiments shown in FIGS. 15A-15C, zone 228 may be a keep-away zone around vias 168. A ground plane for the keyboard PCB, may be squared off up to zone 228. In some embodiments, only key vias and LED vias are allowed in the keep away zone 228. In certain embodiments, a 0.030 inch minimum spacing is maintained between the edge of keep away zone 228 and vias/LEDs.

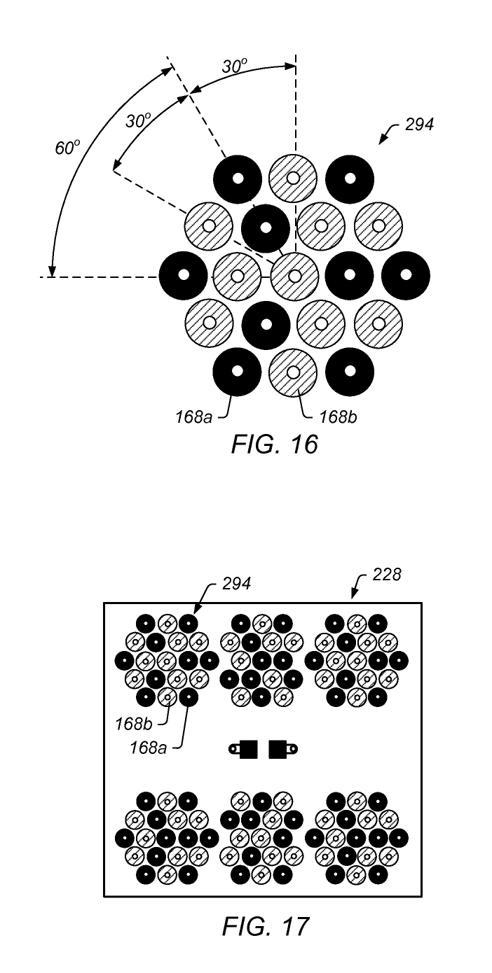

FIG. 16 illustrates a layout diagram of one embodiment of a pattern of vias for a contact area according to one embodiment. Contact area 294 includes vias 168a and 168b. Vias 168a may be coupled on one side of a switch for a key. Vias 168b may be coupled on a second side of a switch for the key.

As is illustrated in FIG. 16, vias 168 may, in one embodiment, be arranged in a hexagonal pattern. In some embodiments, a ring of vias immediately outside a center via may alternate between vias of either side of a switch (168a, then 168b, then 168a, etc.) In certain embodiments, vias one side of may be arranged in an alternating radial pattern.

FIG. 17 illustrates a layout diagram of a portion of a printed circuit board for a key that includes multiple contact areas. Each of contact areas 294 includes multiple vias 168a and multiple vias 168b. As with the keyboard assembly described above with respect to FIGS. 8-11, the number and arrangement of vias, contact areas, and keypad conductive elements for each key may vary from embodiment to embodiment and, within any embodiment, from key to key.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A keyboard system, comprising:
a keypad comprising:
one or more keys; and
one or more keypad conductive elements for at least one of the keys;
a printed circuit board assembly coupled to the keypad, the printed circuit board assembly comprising:
a printed circuit board comprising at least one switch contact areas for each of one or more keys on the keypad; and
for at least one of the keys of the keypad, one or more first side vias in a switch contact area, wherein the first side vias are electrically coupled on a first side of a switch for the key, and one or more second side vias in the switch contact area, wherein the second side vias are electrically coupled on a second side of the switch for the key,
wherein the switch for the key is configurable to close when at least one of the keypad conductive elements bridges at least one first side via in the switch contact area and at least one second side via in the switch contact area.

2. The system of claim 1, wherein, for at least one of the keys, at least one of the switch contact areas comprises one or more first side vias and one or more second side vias.

3. The system of claim 1, wherein, for at least one of the keys, at least one of the first side vias in at least one of the switch contact areas is adjacent to one or more second side vias in at least one switch contact area.

4. The system of claim 1, wherein, for at least one of the keys, at least one of the contact areas comprises one or more second side vias, wherein at least one of the keypad conductive elements is configurable to bridge at least one of the first side vias with at least one of the second side vias, wherein the second via that is bridged with the first side via depends on how the key is pressed.

5. The system of claim 1, wherein, for at least one of the keys, the keypad comprises one or more keypad conductive elements for the key and the printed circuit board comprises one or more switch contact areas for the key, wherein at least one of the keypad conductive elements for the key correspond to a respective one of the switch contact areas for the key.

6. The system of claim 1, wherein, for at least one of the keys, at least one of the first side vias or the second side vias comprises a surface ring configurable to couple with at least one keypad conductive element on the keypad.

7. The system of claim 1, wherein the printed circuit board further comprises one or more ground planes.

8. The system of claim 1, wherein the printed circuit board further comprises one or more ground layers and one or more switching layers, wherein at least one of the ground planes is between the top surface of the printed circuit board and the one or more switching layers.

9. The system of claim 1, wherein the printed circuit board further comprises one or more ground planes, wherein at least one of the vias comprises a surface pad, wherein the ground plane extends under at least a portion of the surface pad.

10. The system of claim 1, wherein at least one of vias comprises a surface pad, wherein the largest dimension of the surface pad is not greater than about 0.040 inches.

11. The system of claim 1, further comprising one or more semiconductor devices configured to electrically couple, for at least one of the keys, one or more first side vias with one another and one or more second side vias with one another.

12. The system of claim 1 further comprising:
a keyboard assembly comprising the keypad and the printed circuit board coupled to the keypad;
a bezel with at least a portion being electrically conductive and configured for panel-mounting the keyboard assembly in a chassis of a computer system and configured to hold one or more fasteners such that fasteners can couple with the chassis, wherein at least one of the fasteners driven from the front of the keyboard assembly into the chassis;
the printed circuit assembly comprising a ground plane on at least a portion of the printed circuit board, wherein at least a portion of the ground plane is configured to couple with the electrically conductive portion of the bezel when the keyboard assembly is coupled with the bezel;
an electrically conductive gasket between the bezel and the chassis, wherein the keyboard assembly is electrically coupled with a chassis ground through the bezel and the electrically conductive gasket.

13. The system of claim 12, wherein the keyboard system is configured to meet a radiated susceptibility test standard under MIL-STD-461E, RS103, at a field strength level of 200 volts/meter.

14. A computer system comprising,
a keyboard assembly comprising a keypad and a printed circuit board coupled to the keypad, wherein the keypad comprises one or more keypad conductive elements;
wherein, for at least one key of the keyboard, the printed circuit board comprises at least one first side via in a switch contact area of the keyboard and at least one second side via in the switch contact area,
wherein at least one switch for the key is configurable to close when at least one of the keypad conductive elements bridges at least one first side via in the switch contact area to at least one second side via in the switch contact area.

15. The computer system of claim 14, wherein the system is configured to meet a radiated susceptibility test standard under MIL-STD-461E, RS103, at a field strength level of 200 volts/meter.

16. A printed circuit board for a keyboard, comprising:
for at least one key, one or more first side vias in a switch contact area; and
for the at least one key, one or more second vias in the switch contact area;
wherein at least one of the first side vias is configurable to couple with a first side of a switch circuit for the key, wherein at least one of the second side vias is configurable to couple with a second side of a switch circuit for the key, wherein a switch in the switch circuit is configurable to close when at least one of the first side vias in the contact area is bridged with at least one of the second side vias in the contact area.

17. A method of improving protection from electromagnetic interference in a keyboard system comprising the steps of:
providing a keypad comprising one or more keys and one or more keypad conductive elements for at least one of the keys;
providing a printed circuit board assembly coupled to the keypad, the printed circuit board assembly comprising:
a printed circuit board comprising at least one switch contact areas for each of one or more keys on the keypad; and
for at least one of the keys of the keypad, one or more first side vias in a switch contact area, wherein the first side vias are electrically coupled on a first side of a switch for the key, and one or more second side vias in the switch contact area, wherein the second side vias are electrically coupled on a second side of the switch for the key,
wherein the switch for the key is configurable to close when at least one of the keypad conductive elements bridges at least one first side via in the switch contact area and at least one second side via in the switch contact area.

18. The method of claim 17, wherein at least one of the switch contact areas comprises one or more first side vias and one or more second side vias.

19. The method of claim 17 wherein for at least one of the keys, at least one of the contact areas comprises one or more second side vias, wherein at least one of the keypad conductive elements is configurable to bridge at least one of the first side vias with at least one of the second side vias, wherein the second via that is bridged with the first side via depends on how the key is pressed.

20. The method of claim 17, wherein, for at least one of the keys, the keypad comprises one or more keypad conductive elements for the key and the printed circuit board comprises one or more switch contact areas for the key, wherein at least one of the keypad conductive elements for the key correspond to a respective one of the switch contact areas for the key.
